(19) United States
(12) Patent Application Publication
(10) Pub. No.: US 2025/0119018 A1
(43) Pub. Date: Apr. 10, 2025

(54) ROTARY MACHINE COIL, METHOD FOR MANUFACTURING SAME, AND ROTARY MACHINE

(71) Applicant: Mitsubishi Electric Corporation, Tokyo (JP)

(72) Inventors: Takahiro MABUCHI, Tokyo (JP); Xiaohong YIN, Tokyo (JP)

(73) Assignee: Mitsubishi Electric Corporation, Tokyo (JP)

(21) Appl. No.: 18/294,561

(22) PCT Filed: Sep. 21, 2021
(86) PCT No.: PCT/JP2021/034492

§ 371 Date: Feb. 2, 2024

(51) Int. Cl. H02K 3/30; H02K 3/34; H02K 3/487; H02K 15/104; H02K 15/122

(52) U.S. Cl. CPC H02K 3/30; H02K 3/34; H02K 3/487; H02K 15/104; H02K 15/122

(57) ABSTRACT

A rotary machine coil includes: a coil conductor; and an insulation layer including a mica tape which is wrapped around an outer periphery of the coil conductor and in which a mica layer and a film layer are laminated in this order from the coil conductor side, and a cured material of a thermosetting resin composition with which the mica layer is impregnated. The permittivity in an insulation layer (first mica layer) on the inner-layer side is higher than the permittivity in an insulation layer (second mica layer) on the outer-layer side, thus reducing the electric field intensity applied in the insulation layer.

### TECHNICAL FIELD

The present disclosure relates to a rotary machine coil, a method for manufacturing the same, and a rotary machine.

### BACKGROUND ART

A large-sized rotary machine used in a turbine electric generator or the like has a stator coil stored in a plurality of slots formed on the inner circumferential side of a stator core. The stator coil is formed of a metal conductor and an insulation material provided therearound. For formation of the insulation material, various processes are used. Examples thereof include a method in which a mica tape obtained by pasting a fiber reinforced material such as glass cloth to mica is wrapped in several turns around a stator coil conductor, then is impregnated with liquid-state thermosetting resin having a low viscosity under a reduced pressure, and thereafter is subjected to hot press (vacuum pressure impregnation), and a method in which semi-cured resin is provided at an insulation tape, and the tape is wrapped around a stator coil conductor and thereafter is subjected to hot press (resin-rich method). A rotary machine manufactured using such a process is increasingly required to be reduced in size and enhanced in efficiency. For achieving these, it is conceivable to thin an insulation material for a stator coil so as to enhance heat-dissipation property. In a case of thinning an insulation material for a stator coil, the electric field intensity in the insulation material increases, and therefore a stator coil having an insulation material with high withstand voltage property is desired.

For example, Patent Document 1 discloses an insulation structure that covers an outer surface of an insulation target in order to electrically insulate the insulation target by covering the outer surface of the insulation target, the insulation structure including a main insulation layer extending in a planar shape along the surface of the insulation target, a fiber reinforced portion extending along the main insulation layer, and a high-molecular-weight polymer portion formed in the fiber reinforced portion so as to bond the main insulation layer and the fiber reinforced portion to each other. In the high-molecular-weight polymer portion, nanoparticles are dispersed, and the density of the nanoparticles is the highest in the fiber reinforced portion. Presence of the nanoparticles dispersed in the high-molecular-weight polymer portion improves withstand voltage property in terms of the insulation life of the insulation material, i.e., long-term reliability thereof.

### CITATION LIST

### Patent Document

Patent Document 1: WO2018/002972 (paragraphs to [0015])

### SUMMARY OF THE INVENTION

### Problem to be Solved by the Invention

It is considered that property improvement by providing nanoparticles (nano filler) in the insulation material is due to suppression of progress of electrical treeing which is an electrical fracture progress phenomenon. Electrical treeing progresses over time in an electric field used in a device, and therefore suppression of progress thereof is effective for improving the insulation life. Meanwhile, in a case of thinning an insulation material for the purpose of size reduction and efficiency enhancement of a device, the electric field intensity at the insulation material increases and therefore, in addition to long-term withstand voltage property, short-term withstand voltage property, i.e., dielectric breakdown voltage of the insulation material, needs to be improved.

Regarding the configuration of the insulation structure, Patent Document 1 has a description about addition of a nano filler effective for improving long-term withstand voltage property. However, since a fracture progress behavior differs between short-term dielectric breakdown and a long-term dielectric breakdown phenomenon, the configuration in Patent Document 1 cannot obtain short-term withstand voltage property, thus having a problem that it is impossible to meet requirements for size reduction and efficiency enhancement of a device.

The present disclosure has been made to solve the above problem, and an object of the present disclosure is to provide a rotary machine coil having an insulation material that is high in short-term and long-term withstand voltage property so as to achieve size reduction and efficiency enhancement of a device, a method for manufacturing the same, and a rotary machine.

### Means to Solve the Problem

A rotary machine coil according to the present disclosure includes: a coil conductor; and an insulation layer including a mica tape which is wrapped around an outer periphery of the coil conductor and in which scale-shaped mica grains overlaid in a thickness direction and a film layer are laminated in this order from the coil conductor side, and a cured material of a thermosetting resin composition with which the scale-shaped mica grains overlaid in the thickness direction are impregnated. A permittivity on an inner-layer side of a mica layer in which the scale-shaped mica grains overlaid in the thickness direction are impregnated with the cured material is higher than a permittivity on an outer-layer side of the mica layer.

A method for manufacturing a rotary machine coil according to the present disclosure includes the steps of: wrapping a fiber layer around an outer periphery of a coil conductor; wrapping, around an outer periphery of the fiber layer, a mica tape in which scale-shaped mica grains overlaid in a thickness direction and a film layer are laminated in this order from the coil conductor side; impregnating the mica grains with a thermosetting resin composition in a liquid state including a nano filler, from an end of the fiber layer through the fiber layer; and heating and curing the thermosetting resin composition.

### Effect of the Invention

According to the present disclosure, the electric field intensity applied to the insulation layer is reduced, whereby not only long-term withstand voltage property but also short-term withstand voltage property can be improved and thus size reduction and efficiency enhancement can be achieved.

### BRIEF DESCRIPTION OF THE DRAWINGS

FIG. 1 is an enlarged schematic perspective view of a part of a stator of a rotary machine including a rotary machine coil according to embodiment 1.

FIG. 2 is a schematic sectional view of an insulation layer of the rotary machine coil according to embodiment 1.

FIG. 3 shows a dispersion state of a nano filler in the insulation layer of the rotary machine coil according to embodiment 1.

FIG. 4 is a flowchart showing a manufacturing process for the rotary machine coil according to embodiment 1.

FIG. 5 is a schematic view showing an impregnation route of a resin composition in the manufacturing process for the rotary machine coil according to embodiment 1.

FIG. 6 is schematic views showing another example of a dispersion state of the nano filler in the insulation layer of the rotary machine coil according to embodiment 1.

FIG. 7 is schematic views showing another example of a dispersion state of the nano filler in the insulation layer of the rotary machine coil according to embodiment 1.

FIG. 8 is schematic views showing another example of a dispersion state of the nano filler in the insulation layer of the rotary machine coil according to embodiment 1.

FIG. 9 is a schematic sectional view showing the configuration of a rotary machine according to embodiment 2.

FIG. 10 is a schematic sectional view showing the configuration of the rotary machine according to embodiment 2.

### DESCRIPTION OF EMBODIMENTS

### Embodiment 1

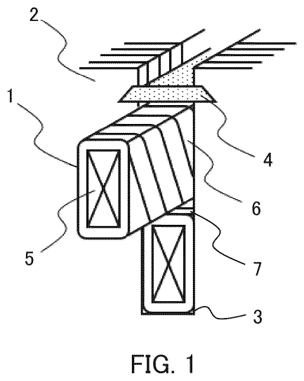

FIG. 1 is an enlarged schematic perspective view of a part of a stator of a rotary machine including a rotary machine coil 1 according to embodiment 1. As shown in FIG. 1, the stator of the rotary machine has the rotary machine coil 1 stored at two stages inside a slot 3 of a stator core 2. A spacer 7 is inserted between the two stages of the rotary machine coil 1, and a wedge 4 for fixing the rotary machine coil 1 is inserted at an opening end of the slot 3. The wedge 4 has an effect of suppressing electromagnetic vibration caused from the rotary machine coil 1 during operation of the rotary machine.

The rotary machine coil 1 includes a coil conductor 5 and an insulation layer 6 coating the coil conductor 5. Since the outer periphery of the coil conductor 5 is coated with the insulation layer 6, the coil conductor 5 is ensured to be insulated from the stator core 2 with respect to the ground, The sectional shape of the coil conductor 5 is rectangular. The coil conductor 5 may be formed of a bundle of a plurality of metal wires having a rectangular sectional shape, for example.

The rotary machine coil 1 of the present disclosure is characterized in that an insulation layer including a mica layer including mica and resin is provided around the outer periphery of a metal conductor and the permittivity on the inner-layer side of the mica layer is higher than on the outer-layer side. More specifically, the rotary machine coil 1 of the present disclosure is characterized in that a fiber layer, a mica layer including mica and resin, and a film layer are arranged in this order as coil insulation materials around the outer periphery of a metal conductor and the permittivity on the inner-layer side of the mica layer is higher than on the outer-layer side of the mica layer.

In general, an insulation layer of a coil is provided around the periphery of a prism-shaped metal conductor. Therefore, an electric field applied in the insulation layer is not uniform and tends to be high in an inner layer of the insulation layer and, in particular, significantly high around a corner of the metal conductor. Thus, dielectric breakdown is likely to progress starting from the corner.

In the present disclosure, the permittivity on the inner-layer side of the mica layer is made higher than on the outer-layer side, whereby an electric field applied in the mica layer is controlled so that an electric field applied in the inner-layer part is relaxed, and thus withstand voltage property can be enhanced, For the mica layer, mainly, mica and a cured material of a thermosetting resin composition in a liquid state are used.

The permittivity of the mica is 4 to 7 and the permittivity of the resin cured material is 3 to 5. In order to produce a permittivity difference inside the mica layer so that the permittivity on the inner-layer side of the mica layer becomes higher than on the outer-layer side, it is conceivable to make a mica filling ratio on the inner-layer side of the mica layer higher than on the outer-layer side or make a resin filling ratio on the outer-layer side higher than on the inner-layer side. However, with this method, it is difficult to sufficiently produce a permittivity difference,

According to the present disclosure, through earnest studies, it has been found out that providing a nano filler having a high permittivity is effective for producing a permittivity difference in order to make the permittivity on the inner-layer side of the mica layer higher than on the outer-layer side. Using this, a configuration in which the permittivity on the inner-layer side of the mica layer is higher than on the outer-layer side is realized.

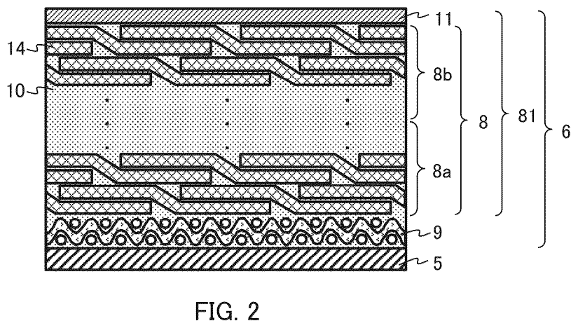

FIG. 2 is a schematic sectional view of the insulation layer of the rotary machine coil 1 according to embodiment 1. As shown in FIG. 2, the insulation layer 6 includes a fiber layer 9 wrapped around the outer periphery of the coil conductor 5, a mica tape 81 wrapped around the outer periphery of the fiber layer 9, and a cured material 10 of a thermosetting resin composition with which the fiber layer 9 and scale-shaped mica grains 14 overlaid in the thickness direction of the mica tape 81 are impregnated. The mica tape 81 includes the scale-shaped mica grains 14 overlaid in the thickness direction and a film layer 11. The cured material 10 includes a nano filler whose dispersion state is controlled in an impregnation region (a range up to ½ of the thickness of a mica layer 8) of a first mica layer 8a on the coil conductor 5 side and an impregnation region (a range above ½ of the thickness of the mica layer 8) of a second mica layer 8b on the outer periphery side of the first mica layer 8a.

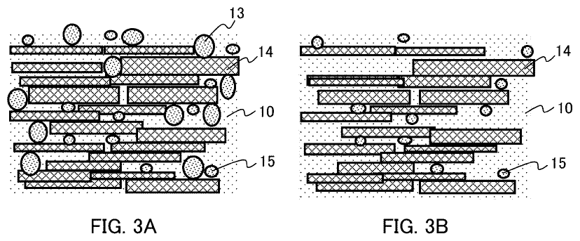

FIG. 3 shows the dispersion state of the nano filler in the insulation layer of the rotary machine coil 1 according to embodiment 1. FIG. 3 (a) is a sectional view showing the inner-layer side of the mica layer 8 and FIG. 3 (b) is a sectional view showing the outer-layer side of the mica layer 8. As shown in FIG. 3 (a), two kinds of nano fillers 13, 15 having different particle sizes are included in the impregnation region of the first mica layer 8a on the inner-layer side. As shown in FIG. 3 (b), only the nano filler 15 having a smaller particle size than the nano filler 13 is included in the impregnation region of the second mica layer 8b on the outer-layer side.

Since the nano filler having a high permittivity is present biasedly in the mica layer 8, a slope of the permittivity is formed between the inner-layer side and the outer-layer side of the mica layer 8, whereby an electric field intensity applied in the insulation layer 6 can be lowered, and thus short-term withstand voltage property is improved. Further, since the nano filler effective for improving long-term withstand voltage property is dispersedly provided in the insulation layer 6, progress of electrical treeing which is a precursor phenomenon for a dielectric breakdown phenomenon is physically blocked so that the progress can be suppressed.

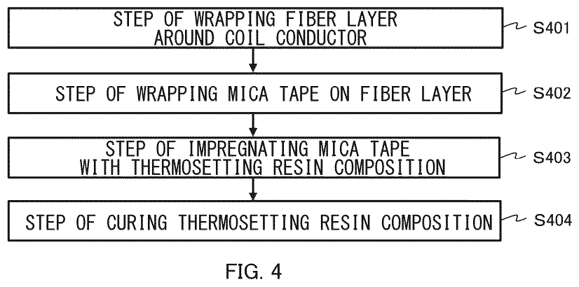

Next, a method for manufacturing the rotary machine coil 1 according to embodiment 1 will be described with reference to FIG. 4. FIG. 4 is a flowchart showing a manufacturing process by the method for manufacturing the rotary machine coil 1 according to embodiment 1.

First, the fiber layer 9 is wrapped around the outer periphery of the coil conductor 5 (step S401). The fiber layer 9 is formed by non-woven fabric or woven fabric made of insulating fiber. Examples of such materials include glass cloth, glass non-woven fabric, and resin non-woven fabric. Among these, glass cloth is excellent in resin impregnation performance and has a mechanical strength reinforcing effect, and thus is preferable.

Subsequently, the mica tape 81 is wrapped around the outer periphery of the fiber layer 9 (step S402). The mica tape 81 includes the scale-shaped mica grains 14 overlaid in the thickness direction and the film layer 11. The film layer 11 is made of resin and has a sheet shape or a tape shape, and needs to be insoluble in liquid-state resin. Examples of such a material of the film layer 11 include a polyethylene film, a polypropylene film, an acrylic film, and a fluorine-containing film.

Next, the mica tape 81 is impregnated with a thermosetting resin composition (step S403). At this time, the fiber layer 9 has a higher resin impregnation coefficient than the scale-shaped mica grains 14 overlaid in the thickness direction and is more readily impregnated with resin than gaps in the mica tape 81. Therefore, a resin impregnation route is formed so as to pass from a coil end through the fiber layer 9 to a coil center part and then pass from the inner-layer side to the outer-layer side of the scale-shaped mica grains 14 overlaid in the thickness direction.

Finally, the thermosetting resin composition is cured in the state in which the mica tape 81 is impregnated (step S404). The thermosetting resin composition is cured by being heated during 6 to 30 hours at a temperature of 90° C. to 180° C. under the ordinary pressure. Through the above process, the rotary machine coil 1 according to embodiment 1 can be manufactured.

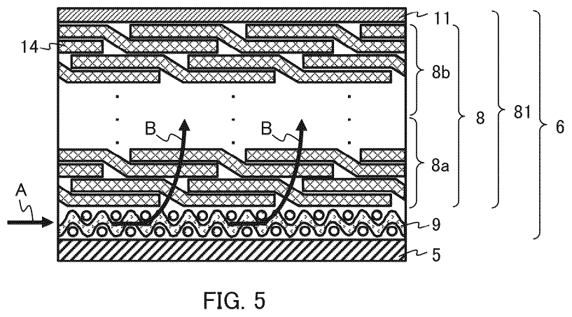

FIG. 5 shows an impregnation route of the thermosetting resin composition to the scale-shaped mica grains 14 overlaid in the thickness direction in the manufacturing process for the rotary machine coil 1 according to embodiment 1. As shown in FIG. 5, the thermosetting resin composition penetrates from an end of the fiber layer 9 in the inward direction (A direction) through the fiber layer 9, then penetrates in the thickness direction (B direction) of the mica grains 14 on the inner-layer side, and finally penetrates in the thickness direction (B direction) of the mica grains 14 on the outer-layer side. Since the film layer 11 which does not allow penetration of resin is provided on the outer side of the mica grains 14, penetration of the thermosetting resin composition ends at the film layer 11.

In general, in a case where a coil having an insulation layer wrapped with a mica tape is impregnated with a thermosetting resin composition in a liquid state, the thermosetting resin composition penetrates from the outer-layer side to the inner-layer side of the insulation layer, or penetrates from a gap at a mica tape end in the insulation layer to the center side,

On the other hand, in a case where the fiber layer 9 used in the configuration of the present disclosure is provided under the inner-layer side of the scale-shaped mica grains 14 overlaid in the thickness direction in the wrapped mica tape 81, the film layer 11 is present on the outer-layer side of the scale-shaped mica grains 14 overlaid in the thickness direction and the film layer 11 has no gaps through which the thermosetting resin composition penetrates, and therefore the thermosetting resin composition in a liquid state does not penetrate from the outer-layer side to the inner-layer side of the scale-shaped mica grains 14 overlaid in the thickness direction. In addition, the fiber layer 9 has a higher resin impregnation coefficient than the scale-shaped mica grains 14 overlaid in the thickness direction and thus is more readily impregnated with the thermosetting resin composition than gaps among the scale-shaped mica grains 14 overlaid in the thickness direction of the mica tape 81. Therefore, a resin impregnation route is formed so as to pass through the fiber layer 9 and then from the inner-layer side to the outer-layer side of the scale-shaped mica grains 14 overlaid in the thickness direction. With this resin impregnation route, the dispersion state of the nano filler included in the thermosetting resin composition is controlled, whereby a configuration in which the permittivity on the inner-layer side of the mica layer 8 is higher than on the outer-layer side can be realized.

The fiber layer 9 is characterized to have a higher resin impregnation coefficient than the scale-shaped mica grains 14 overlaid in the thickness direction, as described above. In this regard, an example of a method for measuring the resin impregnation coefficient will be described. In an impregnation process of the thermosetting resin composition, a behavior of impregnation into a material conforms to Darcy's law and an impregnation speed expression (1) is shown below.

$$v = ( K / μ ) \times ( Δ P / Δ L ) \qquad ( 1 )$$

Here, v is an impregnation speed (m/s), K is a resin impregnation coefficient (m²), u is a resin viscosity (Pa·s), and ΔP/ΔL is a pressure gradient (Pa/m) per unit length,

The above expression is integrated with respect to time t(s), and the resin impregnation coefficient can be obtained by the following Expression (2).

$$K = ( L \times L \times μ ) / ( 2 \times P \times t ) \qquad ( 2 )$$

Here, L is a distance (m) from a resin impregnation entrance to an impregnation resin end, and P is a pressure (Pa) applied in impregnation.

From Expression (2), the impregnation coefficient can be calculated by the distance from the resin impregnation entrance to the end, the arrival time thereof, the resin viscosity, and the formation pressure. In general, in this measurement, the impregnation coefficient is measured for a material placed in a planar shape, to obtain the resin impregnation coefficient K. In the present disclosure, it is desirable that the ratio of the resin impregnation coefficient of the fiber layer to that of the scale-shaped mica grains overlaid in the thickness direction is not less than 2.

In a case where the thermosetting resin composition in a liquid state is combined with the nano fillers 13, 15 and then impregnation is performed through the above resin impregnation route, the nano fillers 13, 15 penetrate from an end of the fiber layer 9 through the fiber layer 9 to the scale-shaped mica grains 14 overlaid in the thickness direction. At this time, since the scale-shaped mica grains 14 overlaid in the thickness direction have a structure in which micro-sized scale-shaped mica grains 14 are laminated, when the nano fillers 13, 15 penetrate in the thickness direction of the mica tape 81, particles of the nano fillers 13, 15 are captured in gaps among the mica grains 14 at certain probabilities so that a density gradient of the nano filler is formed from the fiber layer 9 in the thickness direction in which the scale-shaped mica grains 14 are overlaid. This has been newly found out in the present disclosure.

The above phenomenon occurs because the scale-shaped mica grains 14 are laminated in the thickness direction of the mica tape 81 and among these grains, grain shapes and grain positions are different in the lamination direction and there are parts where laminated grains are overlaid on each other and parts where grains are displaced from each other, so that the nano fillers 13, 15 are filtered. Such a phenomenon is associated with the particle sizes of the nano fillers 13, 15, and it is necessary to control the particle sizes of the nano fillers 13, 15 in order to form a filler density gradient in the thickness direction of the mica tape 81.

In the insulation layer 6 of the rotary machine coil 1 according to embodiment 1, two kinds of nano fillers 13, 15 having different particle sizes are included in the impregnation region of the first mica layer 8a on the inner-layer side, as shown in FIG. 3 (a). The nano filler 13 desirably has an average primary particle size of not less than 70 nm and not greater than 500 nm, and the nano filler 15 desirably has an average primary particle size of not greater than 60 nm and not less than 10 nm. The nano filler 13 is filtered by the first mica layer 8a on the inner-layer side of the mica layer 8 so as to disperse and stay in the first mica layer 8a, and the nano filler 15 is not filtered and disperses uniformly in the entire range over the first mica layer 8a on the inner-layer side and the second mica layer 8b on the outer-layer side of the mica layer 8.

If the average primary particle size of the nano filler 13 is less than 70 nm, a filler density gradient in the thickness direction of the mica layer 8 cannot be formed. If the average primary particle size of the nano filler 13 is greater than 500 nm, particles of the nano filler 13 are captured at the interface between the fiber layer 9 and the innermost layer of the mica tape 81 and therefore are locally placed. Thus, it is impossible to perform effective permittivity control for improving withstand voltage property,

If the average primary particle size of the nano filler 15 is greater than 60 nm, the nano filler 15 hardly has a difference from the nano filler 13 and the dispersion state of the nano filler 15 cannot be controlled relative to the nano filler 13. If the average primary particle size of the nano filler 15 is less than 10 nm, it is impossible to physically block progress of electrical treeing which is a precursor phenomenon for a dielectric breakdown phenomenon, on the inner-layer side of the mica layer 8.

Measurement for the average primary particle sizes of the nano fillers can be performed by a scanning electron microscope (SEM). Regarding the average primary particle sizes of the nano fillers in embodiment 1, nano filler particles were randomly extracted and observed, absolute particle sizes of more than 100 nano filler particles were measured, and the average value of the measured values was used. As a simple way, confirmation can be performed using a median size (50% diameter, D50), and as a measurement method, a laser diffraction scattering particle size distribution device (for example, product name: Microtrac, type: MT3300) may be used.

In order to produce a permittivity difference between the inner-layer side and the outer-layer side of the mica layer 8, each of the nano fillers 13, 15 has a higher permittivity than the cured material 10 of the thermosetting resin composition, desirably has a higher permittivity than the mica, and preferably has a relative permittivity of not less than 7. The mica layer 8 including the above nano fillers 13, 15 has a higher permittivity on the inner-layer side than on the outer-layer side, and thus is effective for improving withstand voltage property. In particular, in a case where a permittivity ratio (inner-layer permittivity/outer-layer permittivity) is controlled to be not less than 1.2, withstand voltage property can be enhanced more effectively.

Examples of the materials of the nano fillers 13, 15 include silica, aluminum oxide, magnesium oxide, boron nitride, aluminum nitride, magnesium hydroxide, calcium carbonate, and magnesium carbonate.

In terms of heat resistance, adhesion, electric insulation, and mechanical strength, the cured material 10 of the thermosetting resin composition is preferably epoxy resin, phenolic resin, silicon resin, or imide resin, and among these, epoxy resin is particularly desirable.

Specifically, the epoxy resin contains an epoxy group in a skeleton and examples of the epoxy resin include bisphenol A epoxy resin, bisphenol F epoxy resin, bisphenol S epoxy resin, biphenol epoxy resin, phenol novolac epoxy resin, cresol novolac epoxy resin, bisphenol A novolac epoxy resin, bisphenol F novolac epoxy resin, alicyclic epoxy resin, aliphatic chain epoxy resin, glycidyl ester epoxy resin, glycidyl amine epoxy resin, hydantoin epoxy resin, isocyanurate epoxy resin, salicylaldehyde novolac epoxy resin, other than the above, a diglycidyl-etherified product of a bifunctional phenol, a diglycidyl-etherified product of a bifunctional alcohol, a halide thereof, and a hydrogenated product thereof. Among these epoxy resins, one kind may be used or two or more kinds may be used. In terms of a balance of cost, viscosity, and heat resistance, a reaction product of epichlorohydrin and a bisphenol A compound is preferably used. Examples of manufactured products of such reaction products include EPIKOTE (trademark) 828 and EPIKOTE (trademark) 825 (product names) (manufactured by Yuka Shell Epoxy Co., Ltd.), EPOTOHTO (trademark) YD128 (product name) (manufactured by Tohto Kasei Co., Ltd.), EPICLON (trademark) 850 (product name) (manufactured by Dainippon Ink and Chemicals Inc.), and SUMI-EPOXY (trademark) ELA-128 (product name) (manufactured by Sumitomo Chemical Industry Company Limited). In order to impart heat resistance to epoxy resin as necessary for coping with heat generation during device operation, epoxy resin containing three or more epoxy groups in a molecule may be used alone or in combination with the above epoxy resin.

Examples of the epoxy resin containing three or more epoxy groups in a molecule include resorcinol diglycidyl ether (1,3-bis-(2,3-epoxypropoxy)benzene), diglycidyl ether of bisphenol A (2,2-bis(p-(2,3-epoxypropoxy)phenyl) propane), triglycidyl p-aminophenol (4-(2,3-epoxypropoxy)-N,N-bis(2,3-epoxypropyl) aniline), diglycidyl ether of bromobisphenol A (2,2-bis(4-(2,3-epoxypropoxy) 3-bromo-phenyl) propane), diglycidyl ether of bisphenol F (2,2-bis(p-(2,3-epoxypropoxy)phenyl) methane), triglycidyl ether of meta- and/or para-aminophenol (3-(2,3-epoxypropoxy) N,N-bis(2,3-epoxypropyl) aniline), tetraglycidyl methylenedianiline (N,N,N′,N′-tetra (2,3-epoxypropyl) 4,4′-diaminodiphenylmethane), cresol novolac epoxy, and phenol novolac epoxy. These resins can enhance heat resistance in accordance with the addition amount thereof, but generally have a high viscosity, resulting in reduction of workability in a formation process for a stator coil insulation coating material. Therefore, the addition amount and heat resistance are required to be balanced. In terms of this, phenol novolac epoxy or cresol novolac epoxy is particularly preferable,

As described above, the rotary machine coil 1 according to embodiment 1 includes: the coil conductor 5; and the insulation layer including the mica tape 81 which is wrapped around the outer periphery of the coil conductor 5 and in which the scale-shaped mica grains 14 overlaid in the thickness direction and the film layer 11 are laminated in this order from the coil conductor 5 side, and the cured material 10 of the thermosetting resin composition with which the overlaid mica grains 14 are impregnated. The permittivity in a layer (first mica layer 8a) on the inner-layer side of the mica layer 8 in which the scale-shaped mica grains 14 overlaid in the thickness direction are impregnated with the cured material 10 is higher than the permittivity in a layer (second mica layer 8b) on the outer-layer side of the mica layer 8. Thus, an electric field intensity applied in the insulation layer is reduced, whereby not only long-term withstand voltage property but also short-term withstand voltage property can be improved and thus size reduction and efficiency enhancement can be achieved.

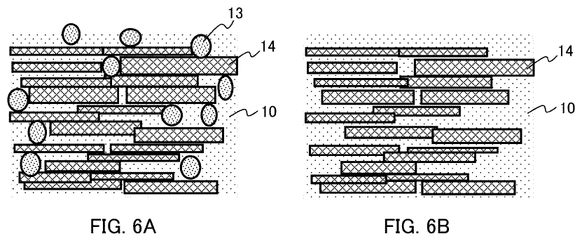

In embodiment 1, two kinds of nano fillers 13, 15 having different particle sizes are used, but the present disclosure is not limited thereto. FIG. 6 to FIG. 8 show dispersion states of nano fillers in other insulation layers of the rotary machine coil 1 according to embodiment 1.

As shown in FIG. 6, only the nano filler 13 may be included in the impregnation region of the mica layer 8a on the inner-layer side (FIG. 6 (a)) and no nano filler may be included in the impregnation region of the mica layer 8b on the outer-layer side (FIG. 6 (b)).

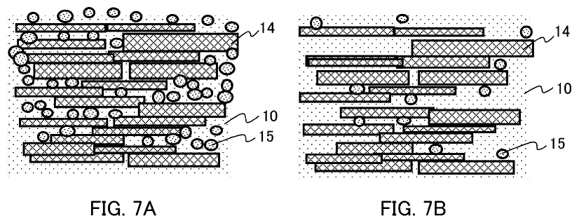

As shown in FIG. 7, the nano filler 15 may be included at a high filling ratio in the impregnation region of the mica layer 8a on the inner-layer side (FIG. 7 (a)) and the nano filler 15 may be included at a lower filling ratio in the impregnation region of the mica layer 8b on the outer-layer side than on the inner-layer side (FIG. 7 (b)).

The above configuration is formed in a case where the nano filler has a wide particle size distribution and has an average primary particle size of not less than 70 nm and nano filler particles with particle sizes of not greater than 60 nm are included at a ratio of less than 50% with respect to the number of particles in the entire nano filler.

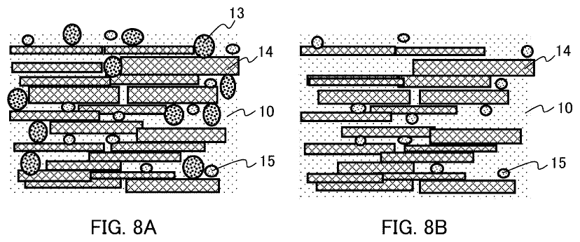

As shown in FIG. 8, in the impregnation region of the mica layer 8a on the inner-layer side, the two kinds of nano fillers 13, 15 having different particles sizes in embodiment 1 may be different also in their materials (FIG. 8 (a)), and in the impregnation region of the mica layer 8b on the outer-layer side, only the nano filler 15 having a smaller particle size than the nano filler 13 may be included (FIG. 8 (b)). Further, three or more kinds of nano fillers may be used in combination, and nano fillers may have different particle size distributions.

### Embodiment 2

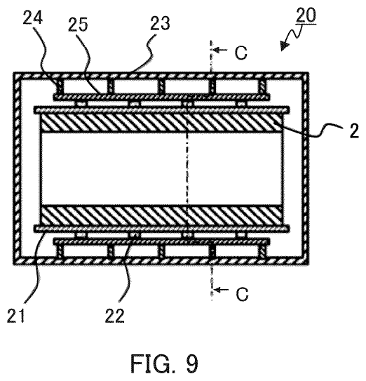

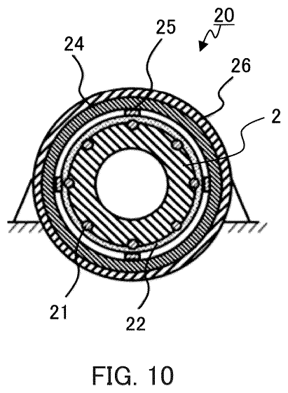

FIG. 9 is a schematic sectional view along a rotation axis of a rotary machine 20 according to embodiment 2. FIG. 10 is a schematic sectional view perpendicular to the rotation axis of the rotary machine 20 according to embodiment 2, as seen in an arrow-C direction in FIG. 9.

In FIG. 9 and FIG. 10, the rotary machine 20 according to the embodiment includes a rotor core (not shown), a cylindrical stator core 2 surrounding the rotor core, a plurality of core tightening members 21, a plurality of retention rings 22, a frame 23, a plurality of inner-framework members 24, and a plurality of elastic support members 25. Although not shown in FIG. 9 and FIG. 10, a plurality of slots extending in the axial direction are arranged in the circumferential direction at the inner circumference of the stator core 2. In the slots, the rotary machine coil 1 described in embodiment 1 is stored. In FIG. 9 and FIG. 10, eight core tightening members 21 are used, but the number of the core tightening members 21 is not limited thereto. In FIG. 9 and FIG. 10, the retention rings 22 are provided at four locations, but the number of the retention rings 22 is not limited thereto. In FIG. 9 and FIG. 10, the inner-framework members 24 are provided at five locations, but the number of the inner-framework members 24 is not limited thereto. In FIG. 9 and FIG. 10, four elastic support members 25 are used, but the number of the elastic support members 25 is not limited thereto. The core tightening members 21 are arranged with intervals therebetween in the circumferential direction, at the outer circumference of the stator core 2. The core tightening members 21 tighten the stator core 2. The retention rings 22 are formed in a flattened shape in the axial direction. The retention rings 22 are arranged with intervals therebetween in the axial direction, at the outer circumference of the stator core 2. The retention rings 22 tighten and retain the stator core 2 from the outer circumferential side of the core tightening members 21. The frame 23 is formed in a cylindrical shape and surrounds the stator core 2 with a gap therebetween. The inner-framework members 24 are formed in a ring shape, and are arranged with intervals therebetween in the axial direction, at the inner surface of the frame 23. The inner-framework members 24 protrude radially inward from the inner surface of the frame 23. Each elastic support member 25 is a spring plate which is fixed to the inner-framework members 24 adjacent to each other and is, at an axial-direction center part therebetween, fixed to the retention ring 22. The rotary machine shown in FIG. 9 and FIG. 10 is applicable to a turbine electric generator having an armature, for example.

In the rotary machine 20 according to embodiment 2, since short-term and long-term withstand voltage property of the rotary machine coil 1 is improved, further size reduction and output increase can be achieved. In particular, in a case where the rotary machine 20 according to embodiment 2 is applied to a turbine electric generator, the thickness of the insulation layer coating the coil conductor can be reduced as compared to a conventional case. Thus, heat generation in the coil conductor can be reduced and output efficiency of the turbine electric generator can be improved.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 rotary machine coil
2 stator core
3 slot
4 wedge
5 coil conductor
6 insulation layer
7 spacer
8, 8a, 8b mica layer
9 fiber layer
10 cured material of thermosetting resin
composition
11 film layer
13 nano filler
14 mica grain
15 nano filler
20 rotary machine
21 core tightening member
22 retention ring
23 frame
24 inner-framework member
25 elastic support member
81 mica tape

1.-7. (canceled)

8. A rotary machine coil comprising:
a coil conductor;
an insulation layer including
a mica tape which is wrapped around an outer periphery of the coil conductor and in which scale-shaped mica grains overlaid in a thickness direction and a film layer are laminated in this order from the coil conductor side, and
a cured material of a thermosetting resin composition with which the scale-shaped mica grains overlaid in the thickness direction are impregnated; and
a nano filler included in the cured material and having a higher permittivity than the cured material, wherein
a permittivity on an inner-layer side of a mica layer in which the scale-shaped mica grains overlaid in the thickness direction are impregnated with the cured material is higher than a permittivity on an outer-layer side of the mica layer,
the mica grains on the inner-layer side of the mica layer and the mica grains on the outer-layer side of the mica layer are made of the same material, and
the nano filler is present biasedly on the inner-layer side and the outer-layer side of the mica layer, the nano filler has a higher density on the inner-layer side than on the outer-layer side, the nano filler includes a first nano filler having a great particle size and a second nano filler having a smaller particle size than the first nano filler, and the second nano filler has a lower density on the outer-layer side than on the inner-layer side.

9. The rotary machine coil according to claim 8, wherein
a relative permittivity of the nano filler is not less than 7.

10. The rotary machine coil according to claim 8, wherein
materials of the first nano filler and the second nano filler are different from each other.

11. The rotary machine coil according to claim 9, wherein
materials of the first nano filler and the second nano filler are different from each other.

12. The rotary machine coil according to claim 8, further comprising a fiber layer provided between the coil conductor and the mica layer, wherein
a ratio of a resin impregnation coefficient of the fiber layer to that of the scale-shaped mica grains overlaid in the thickness direction is not less than 2, the resin impregnation coefficient being represented by the following Expression (2):
$$K = ( L \times L \times μ ) / ( 2 \times P \times t ) \qquad ( 2 )$$
where K is the resin impregnation coefficient (m²), L is a distance (m) from a resin impregnation entrance to an impregnation resin end, μ is a resin viscosity (Pa·s), P is a pressure (Pa) applied in impregnation, and t is time(s).

13. The rotary machine coil according to claim 9, further comprising a fiber layer provided between the coil conductor and the mica layer, wherein
a ratio of a resin impregnation coefficient of the fiber layer to that of the scale-shaped mica grains overlaid in the thickness direction is not less than 2, the resin impregnation coefficient being represented by the following Expression (2):
$$K = ( L \times L \times μ ) / ( 2 \times P \times t ) \qquad ( 2 )$$
where K is the resin impregnation coefficient (m²), L is a distance (m) from a resin impregnation entrance to an impregnation resin end, μ is a resin viscosity (Pa·s), P is a pressure (Pa) applied in impregnation, and t is time(s).

14. The rotary machine coil according to claim 10, further comprising a fiber layer provided between the coil conductor and the mica layer, wherein
a ratio of a resin impregnation coefficient of the fiber layer to that of the scale-shaped mica grains overlaid in the thickness direction is not less than 2, the resin impregnation coefficient being represented by the following Expression (2):
$$K = ( L \times L \times μ ) / ( 2 \times P \times t ) \qquad ( 2 )$$
where K is the resin impregnation coefficient (m²), L is a distance (m) from a resin impregnation entrance to an impregnation resin end, μ is a resin viscosity (Pa·s), P is a pressure (Pa) applied in impregnation, and t is time(s).

15. The rotary machine coil according to claim 11, further comprising a fiber layer provided between the coil conductor and the mica layer, wherein
a ratio of a resin impregnation coefficient of the fiber layer to that of the scale-shaped mica grains overlaid in the thickness direction is not less than 2, the resin impregnation coefficient being represented by the following Expression (2):
$$K = ( L \times L \times μ ) / ( 2 \times P \times t ) \qquad ( 2 )$$
where K is the resin impregnation coefficient (m²), L is a distance (m) from a resin impregnation entrance to an impregnation resin end, μ is a resin viscosity (Pa·s), P is a pressure (Pa) applied in impregnation, and t is time(s).

16. A method for manufacturing a rotary machine coil, comprising the steps of:
wrapping a fiber layer around an outer periphery of a coil conductor;
wrapping, around an outer periphery of the fiber layer, a mica tape in which scale-shaped mica grains overlaid in a thickness direction and a film layer are laminated in this order from the coil conductor side;
impregnating the scale-shaped mica grains overlaid in the thickness direction with a thermosetting resin composition in a liquid state including a nano filler having a higher permittivity than the thermosetting resin composition, from an end of the fiber layer through the fiber layer; and
heating and curing the thermosetting resin composition, wherein
the mica grains on an inner-layer side of a mica layer in which the scale-shaped mica grains overlaid in the thickness direction are impregnated with the thermosetting resin composition, and the mica grains on an outer-layer side of the mica layer, are made of the same material, and
the nano filler includes a first nano filler having a great particle size and a second nano filler having a smaller particle size than the first nano filler, and the second nano filler has a lower density on the outer-layer side than on the inner-layer side.

17. A rotary machine comprising:
a rotor core; and
a stator core, wherein
the rotary machine coil according to claim 8 is stored in slots of the stator core.

18. A rotary machine comprising:
a rotor core; and
a stator core, wherein
the rotary machine coil according to claim 9 is stored in slots of the stator core.

19. A rotary machine comprising:
a rotor core; and
a stator core, wherein
the rotary machine coil according to claim 10 is stored in slots of the stator core.

20. A rotary machine comprising:
a rotor core; and
a stator core, wherein
the rotary machine coil according to claim 11 is stored in slots of the stator core.

21. A rotary machine comprising:
a rotor core; and
a stator core, wherein
the rotary machine coil according to claim 12 is stored in slots of the stator core.

22. A rotary machine comprising:
a rotor core; and
a stator core, wherein
the rotary machine coil according to claim 13 is stored in slots of the stator core.

23. A rotary machine comprising:
a rotor core; and
a stator core, wherein
the rotary machine coil according to claim 14 is stored in slots of the stator core.

24. A rotary machine comprising:
a rotor core; and
a stator core, wherein
the rotary machine coil according to claim 15 is stored in slots of the stator core.
